(19) United States
(12) Patent Application Publication
(10) Pub. No.: US 2022/0125666 A1
(43) Pub. Date: Apr. 28, 2022

(54) DEVICES AND METHODS FOR LYMPHEDEMA TREATMENT

(71) Applicant: Board of Supervisors of Louisiana State University and Agricultural and Mechanical College, Baton Rouge, LA (US)

(72) Inventors: Hunter Gilbert, Baton Rouge, LA (US); Mohammad Imrul Kayes, Baton Rouge, LA (US); Connie McKnight, New Orleans, LA (US); Noah Foster, Baton Rouge, LA (US)

(21) Appl. No.: 17/451,582

(22) Filed: Oct. 20, 2021

Related U.S. Application Data
(60) Provisional application No. 63/104,692, filed on Oct. 23, 2020.

(51) Int. Cl. A61H 9/00

(52) U.S. Cl. CPC A61H 9/0092; A61H 2201/1638; A61H 2201/1642; A61H 2230/085; A61H 2201/5028; A61H 2205/06; A61H 2205/10; A61H 2201/5007

(57) ABSTRACT

Provided herein are compression devices and methods of use thereof, and methods of treatment for patients with edema. The compression device can include a sleeve having a plurality of inflatable chambers and at least one pneumatic pump that can be coupled to at least one inflatable chamber. The device can also include a portable bio impedance analyzer, a microcontroller and a battery. The battery can power the microcontroller and the at least one pneumatic pump and the microcontroller can control the both the portable bio impedance analyzer and the at least one pneumatic pump. The device can be used to treat a patient. Body impedance values are received from the sensors. The inflatable chambers are inflated in a sequence and to a pressure level based on the instructions from the microcontroller when the body impedance values meet a first predefined threshold.

### CROSS-REFERENCE TO RELATED APPLICATIONS

This application claims the benefit of and priority to U.S. Provisional Application Ser. No. 63/104,692, having the title “DEVICES AND METHODS FOR LYMPHEDEMA TREATMENT”, filed on Oct. 14, 2021, the disclosure of which is incorporated herein by reference in its entirety.

### BACKGROUND

Lymphedema refers to swelling in arms or legs caused by the removal or damage to lymph nodes as a part of cancer treatment. Management of lymphedema consists of manual lymphatic drainage, applying intermittent pneumatic compression (IPC) by a stationary pump, and wearing compression garments. Existing IPC technologies require a patient to wear a bulky and uncomfortable compression garment and be tethered to a stationary pump during the duration of the process.

### SUMMARY

Embodiments of the present disclosure provide compression devices, methods of use, and methods of treatments for patients with edema, and the like.

An embodiment of the present disclosure includes a compression device. The device can include a sleeve having a plurality of inflatable chambers and at least one pneumatic pump. The pump can be coupled to at least one inflatable chamber. The device can also include a portable bio impedance analyzer, a microcontroller and a battery. The battery can power the microcontroller and the at least one pneumatic pump and the microcontroller can control the both the portable bio impedance analyzer and the at least one pneumatic pump.

An embodiment of the present disclosure also includes methods of treating a patient with a compression device. A plurality of sensors and a sleeve can be attached to a patient's limb. The sleeve can have a plurality of inflatable chambers. Body impedance values are received from the sensors by a bio impedance circuit connected to a microcontroller. Instructions are sent from the microcontroller to a plurality of pumps based on the values received by the bio impedance circuit. The inflatable chambers are inflated in a sequence and to a pressure level based on the instructions from the microcontroller when the body impedance values meet a first predefined threshold.

Other apparatus, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure.

FIG. 1 is a diagram illustrating a decision tree used in the treatment of lymphedema.

FIG. 2 is a diagram illustrating a smart pneumatic compression device in accordance with embodiments of the present disclosure.

FIG. 3 is a camera image of an example of a prototype illustrating a smart pneumatic compression device in accordance with embodiments of the present disclosure.

FIG. 4 is a diagram illustrating a smart pneumatic compression device in accordance with embodiments of the present disclosure.

FIG. 5 is a camera image of an example of chamber specifications of prototype compression sleeve in accordance with embodiments of the present disclosure.

FIG. 6 is a schematic of four compression chambers connected to pneumatic pumps in accordance with embodiments of the present disclosure.

FIG. 7 is a pneumatic pump and battery assembly used for testing of compression of chambers in accordance with embodiments of the present disclosure.

FIGS. 8A-8C are examples of BIA measurement circuit schematics in accordance with embodiments of the present disclosure. FIG. 8A is a schematic of a BIA circuit developed for impedance measurements of a test circuit. FIG. 8B demonstrates use of ATmega328P-PU as signal generator for BIA circuit. FIG. 8C demonstrates use of oscilloscope as signal generator for BIA circuit.

FIG. 9 is a schematic of test circuit used for BIA analysis in accordance with embodiments of the present disclosure.

FIG. 10 demonstrates the time required for four chambers to reach target pressure in accordance with embodiments of the present disclosure.

FIG. 11 demonstrates the voltage vs pressure curve for four chambers in accordance with embodiments of the present disclosure. The supply voltage ranged from 4 V to 6 V.

FIG. 12 demonstrates the comparison of Nyquist plot obtained from a prototype circuit and LCR meter in accordance with embodiments of the present disclosure. The frequency ranged from 100 Hz to 100 kHz with a peak-to-peak drive amplitude of 1 V.

FIG. 13 demonstrates sequential operation of pumps for a total duration of 180 seconds in accordance with embodiments of the present disclosure.

The drawings illustrate only example embodiments and are therefore not to be considered limiting of the scope described herein, as other equally effective embodiments are within the scope and spirit of this disclosure.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of biomedical engineering, mechanical engineering and the like, which are within the skill of the art.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

In accordance with the purpose(s) of the present disclosure, as embodied and broadly described herein, embodiments of the present disclosure, in some aspects, relate to compression treatment and bio impedance sensing.

In general, embodiments of the present disclosure provide for devices for compressive therapy, methods of treating patients having circulatory and/or lymphatic conditions such as lymphedema, and methods of using compressive devices.

The present disclosure includes a device for compressive therapy. Advantageously, the device includes both compressive therapy and bio impedance sensing.

Embodiments of the present disclosure include a compressive therapy device as above, wherein the compression includes a sleeve comprising a plurality of inflatable chambers. At least one pneumatic pump can be coupled to at least one inflatable chamber. The device also includes a portable bio impedance analyzer, a microcontroller, and a battery. The battery powers the microcontroller and the pneumatic pump(s). The microcontroller controls the portable bio impedance analyzer and pneumatic pumps.

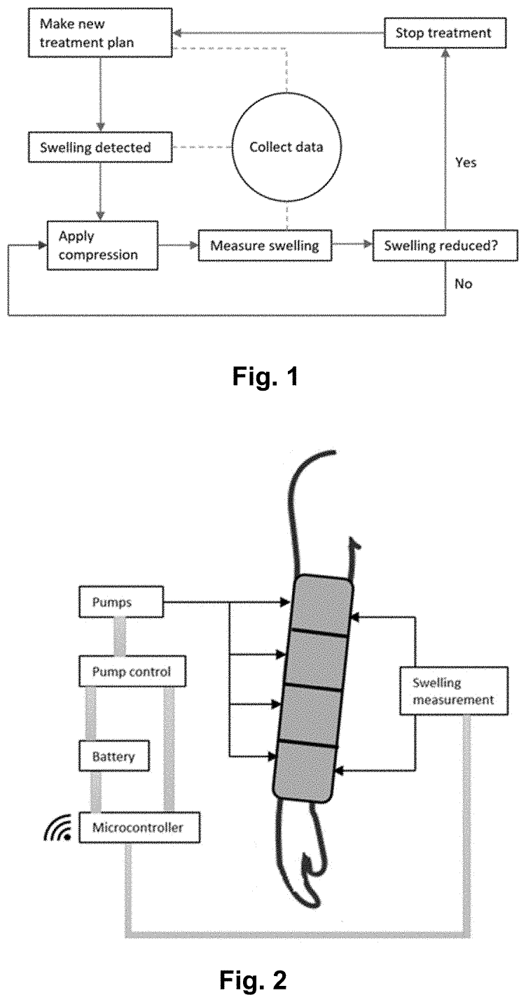

Advantageously, the device described herein can be both smart and portable. The device can apply pneumatic compression based on the amount of swelling in at least one affected arm or leg. The device can include sensors, battery-operated small pumps, and a compression sleeve. The portable bio impedance analyzer includes sensors that can be attached to the sleeve and placed across the length of the arm or leg. Bioimpedance spectroscopy (BIS) analysis can be performed by the sensors by sending an electrical signal through the intended area (further details are provided in Example 3). A semicircular Nyquist plot (often referred to as a Cole-Cole plot) measuring real and imaginary impedance can be obtained by changing signal frequencies. A change in the shape of the plot indicate a variation in fluid level. The sensors can detect information on treatment and swelling condition, total body water, and tissue mass, which can be used for future assessment. The control systems for sensors and pneumatic pumps can be integrated in a circuit. The information can be processed and stored by such as a microcontroller. Battery-operated pumps can be used to provide pneumatic compression. The pumps can be activated upon the detection of swelling by the sensors. While in operation, pumps can provide sequential compression through chambers in the compression sleeve. This will help move lymph fluid away from the affected area. Once the swelling goes down to a predetermined level, sensors can detect the reduction, causing the pumps to stop automatically. The sleeve can then activate as needed to maintain the predetermined level. An overview of one possible embodiment of the operation of the device is shown in FIG. 1.

In some embodiments, each chamber is connected to one pump. In other embodiments, a pump can inflate more than one chamber via valves.

In some embodiments, the pneumatic pump(s), the portable bio impedance analyzer, the microcontroller, and the battery can be contained within a wearable pack. In some embodiments, one or more of the pneumatic pump(s), the portable bio impedance analyzer, the microcontroller, and the battery can be contained within a wearable pack.

The compression device can include one or more pressure sensors that sense the pressure inside the inflatable chambers. The pressure inside the inflatable chambers is substantially the same as the pressure applied to the user's skin. Data from the pressure sensor can be sent to the microcontroller.

In some embodiments, the inflatable chambers are inflated sequentially. The pressure and the duration of the inflation is controlled in response to the data received from the portable bio impedance analyzer.

In embodiments, the pressure in each inflatable chamber can be the same as or can be different from one another, and the maximum pressure in each inflatable chamber can be about 0 to 90 mmHg, about 0 to 60 mmHg, or about 0 to 40 mmHg.

In some embodiments, the pneumatic pump(s) can be a 4.5 V DC-motor-driven gas diaphragm pump.

The data received from the sensors placed on the user's skin can be selected from such as total body water, extra-cellular fluid, intra-cellular fluid, fat mass, and fat free mass of the user, where Total body water (TBW) is the sum of intra-cellular fluid (ICF) and extra-cellular fluid (ECF).

Body impedance values can be calculated from this data by the bioimpedance analyzer integrated with the microcontroller. When the body impedance values meet predetermined thresholds, the pump controller integrated within the microcontroller can activate or deactivate the pumps.

In some embodiments, the portable bio impedance analyzer comprises at least one sensor and a bio impedance circuit, wherein the bio impedance circuit sends small, controlled currents (e.g. signals) through the body and enables high impedance voltage sampling by the microcontroller.

The microcontroller can be in wireless communication with a computing device. For example, the user can control settings such as duration of the compressive therapy via an app. The user or medical professional can also input specific therapies, patient data (e.g. weight, height, blood pressure), or monitor progress using the app. A general diagram of an embodiment of the compressive device (shown here as an arm sleeve) is provided in FIG. 2.

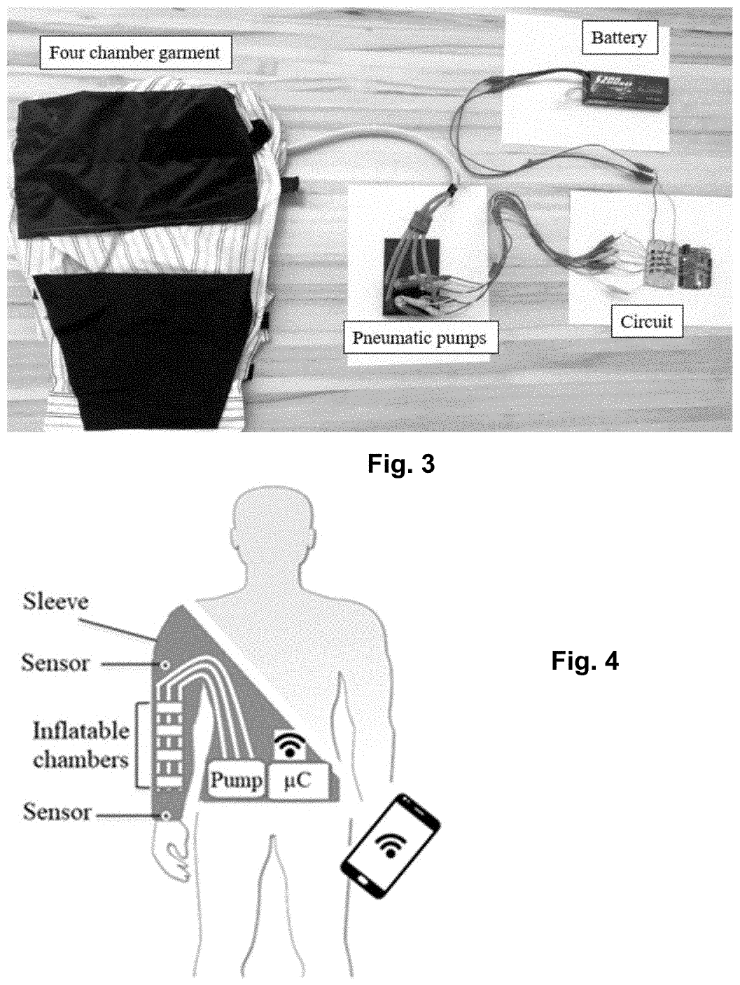

The compression garment used for treating upper extremity lymphedema can have multiple chambers. The number of chambers can range from about 3 to 12. One embodiment of a 4-chamber device is shown in FIG. 3. The pumps, circuit (bioimpedance analyzer and microcontroller), and battery are shown for demonstration purposes, but could be incorporated into the sleeve or into a wearable pack during use.

In some embodiments, the entire device is wearable, such that a patient can be ambulatory during treatment. In some embodiments, the entire device will be combined in specially designed garment (e.g. lymphedema shirt, sleeve, pants, soft boots) eliminating the need to wear any additional garments. Thus, the proposed technology will provide freedom of movement and reduce the discomfort associated with current devices. The ease of access to information regarding swelling condition over time should also help patients perform better lymphedema management. In some embodiments, the at least one pneumatic pump, the portable bio impedance analyzer, the microcontroller, and the battery are contained within a wearable pack connected to the lymphedema garment.

Advantageously, this can enhance mobility by allowing freedom of movement. The lightweight, wearable sleeve is also expected to provide greater comfort, in comparison to the more rigid materials of traditional compression garments, during the course of the treatment. Advantageously, the device can be used for other conditions, such as non-lymphatic edema, DVT, (prevention or treatment), circulatory conditions, or even sports therapy.

Also provided herein are methods of treating a patient with a compression device as described above. The sleeve can be attached to a patient's limb. The sensors sense body impedance values and provide the values to a bio impedance circuit connected to a microcontroller. Instructions are sent from the microcontroller to a plurality of pumps based on the data received by the bio impedance circuit. The chambers are inflated based on the instructions from the microcontroller.

The duration, pressure, and sequence of the inflating can be adjusted according to the body impedance values received from the sensors.

When a predetermined threshold (e.g. time or a level of swelling) has been reached, the pumps can stop automatically. The pumps can be restarted should a second predetermined threshold be reached. For example, the predetermined threshold may be based on a real-time estimation of maximum achievable limb volume reduction over short timescales, such as 86% of the maximum achievable limb volume reduction. Another potential threshold is the duration of compression treatment (e.g. total 1 hour per day over 4 sessions), or other threshold suggested by current guidelines.

In some embodiments, the chambers can be formed from heat sealable, polymer-coated nylon fabric. The material should be able to withstand frequent washing, exposure to sun, and stretching. It should be able to provide effective compression for four to six months. Other materials such as latex or TPU suitable for repeated inflation and deflation can be envisioned by one of ordinary skill in the art.

The outer layer of the sleeve can comprise materials suitable for compression garments including but not limited to cotton, canvas, fleece, polyester, or other materials suitable for contact with the skin.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

Lymphedema is a chronic condition that needs continuous and meticulous care. Complete decongestive physiotherapy (CDP) is an effective option for the initial treatment of lymphedema. The treatment includes manual lymphatic drainage (MLD), compression stockings and bandages, and pneumatic compression [9]. Study suggests that patients who showed compliance with CDP had an average reduction of 59% in upper extremity volume on a 9-month follow-up [16]. However, CDP involves care by a trained specialist in a clinical setting and therefore it cannot be sustained forever. Patients must eventually transition into self-care in an at-home setting [17].

Sequential pneumatic compression is an essential part of lymphedema treatment. Use of compression devices as a part of CDP showed reduced limb volume and improved lymphatic function [18], [19]. Recent guidelines suggest using pneumatic compression devices for 1 hour per day with maximum pressure ranging from 30 mmHg to 60 mmHg [19]. A typical pneumatic compression device consists of a compression garment having single or multiple chambers and a pneumatic pump.

There are existing devices that provide pneumatic compression devices for lymphedema. These devices require patients to wear a bulky and uncomfortable compression garment and be tethered to a stationary pneumatic pump during the duration of the process. Moreover, no such device currently exists that can monitor treatment progress over time and provide feedback. Monitoring treatment progress can include monitoring the level of edema, monitoring treatment duration, or other quantities. Feedback control can be changed based on changing guidelines in medical literature (e.g. duration, or levels detected by BIA analysis).

For the measurement of edema, a non-invasive technique called bio impedance analysis (BIA) is used to monitor changes in total body water, extra and intra-cellular fluid, fat mass, and fat free mass [13]. Bio impedance spectroscopy analysis (BIS) is the most advanced form of BIA which measures fluid and tissue volume that gives an accurate indication of lymphedema. The technique is capable of detecting lymphedema symptoms by measuring the change in extra-cellular fluid in the body. Typically, a Nyquist plot of the body's response is obtained by plotting real and imaginary impedance of the body for a sweep of test frequencies. A mixture model of the tissue indicates that quantities of extracellular water and total water correspond to impedance measured at a very low (zero) frequency and a very high (infinite) frequency [14].

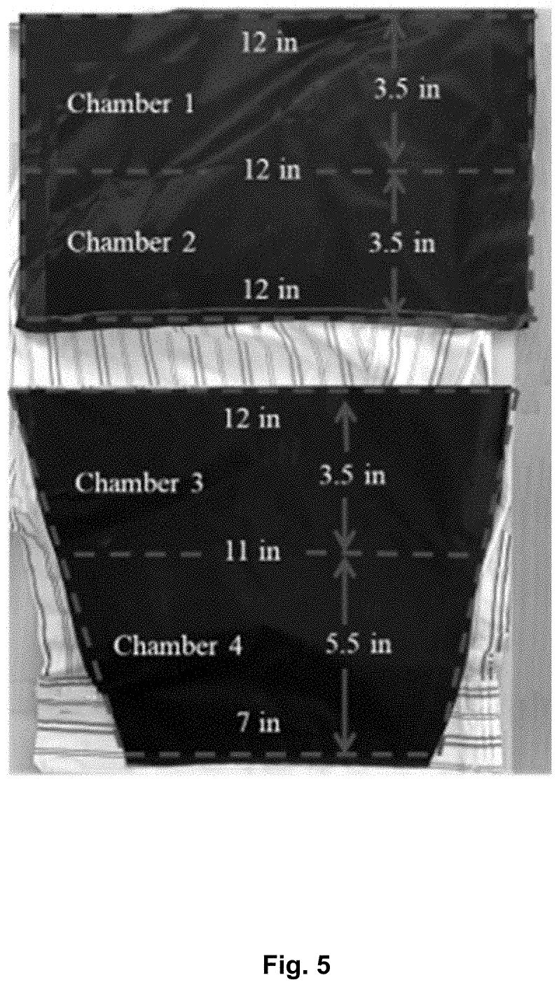

A feedback-based smart compression system that monitors the progress and adjusts treatment courses may provide a better solution to lymphedema management (FIG. 4) than existing compression garments. Described herein is a dynamic compression device that can help improve the quality of life for individuals who have conditions such as upper extremity lymphedema. The device has small, battery operated pneumatic pumps to apply compression in a multi-chamber compression garment. In a particular embodiment, the garment is a four-chamber garment. The portability and ‘ease of use’ of the device may improve psychological and functional well-being of the user. The BIA system that measures real and imaginary impedance of the arm is also described.

Materials and Methods

Design of Compression System—A compression garment consisting of four separate chambers was made, as depicted in FIG. 5. The chambers were cut from a single sheet of heat sealable, polymer-coated nylon fabric (Seattle Fabric Inc., Seattle, Wash., USA) and sealed using an impulse sealer. The fabric was anti-microbial and fire retardant. The sleeve was cut from an extra-large shirt with a length of 22 in. A lengthwise cut was made to allow the chambers to be sewn onto the inside of the sleeve. Adjustable straps (VELCRO™, Manchester, N.H., USA) were sewn onto the outside of the sleeve so the sleeve could be easily attached and removed from the user. Other closures such as buttons, zippers, toggles, straps and buckles, or hook and eyes can be used as can be envisioned by one of ordinary skill in the art. The dimensions and arrangement of the chambers shown in FIG. 5 are one example of several possible embodiments.

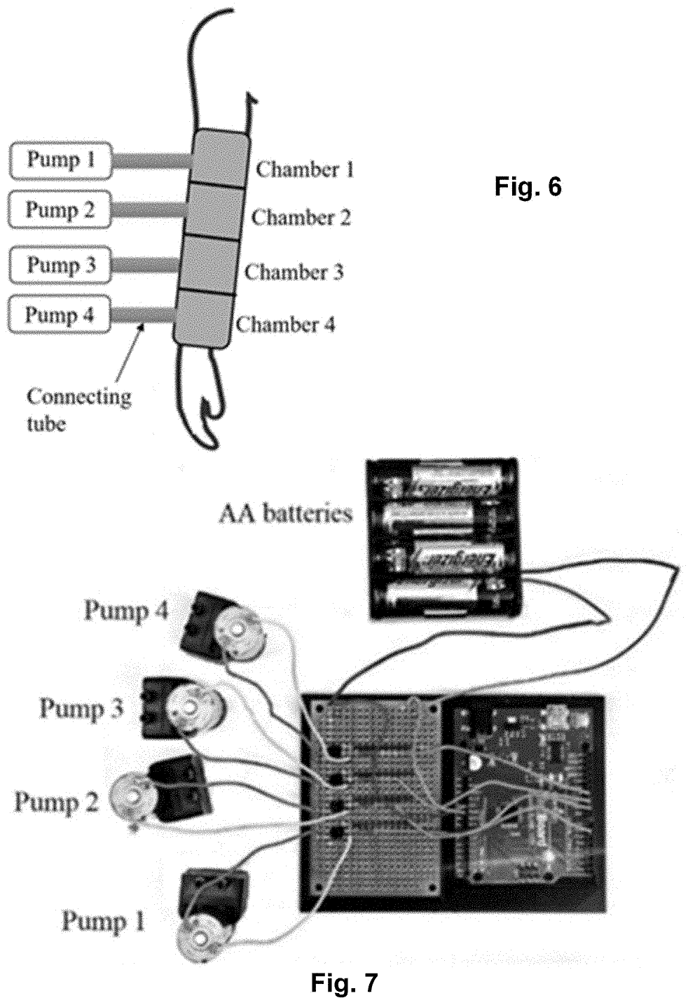

Four 22K series 4.5 V DC-motor-driven gas diaphragm pumps manufactured by Boxer GmbH (Ottobeuren, Germany) were used for compression. Each pump was rated for a maximum pressure of 300 mbar (225 mmHg). The outlet valves of the pumps were connected to different chambers of the compression garment by a silicone rubber tube with an outer diameter of 6.50 mm and an inner diameter of 3.50 mm (FIG. 6). This enabled the chambers to inflate and deflate separately. Smaller, custom pumps having an appropriate flow rate can be substituted.

When inflated, the sleeve is approximately 2 inches thick.

In a particular embodiment, a Zeee 5200 mAh 7.4 V battery was used to run the pumps. A Sparkfun RedBoard (Sparkfun Electronics, Boulder, Colo., USA) was used to operate the pumps using Arduino Integrated Development Environment (IDE). The circuit consisted of BC 547C NPN bipolar transistors with a base resistor value of 530) (FIG. 7). As can be envisioned by one of ordinary skill in the art, other power assemblies can be used, such as lithium-ion batteries.

A code was developed in Arduino IDE for a sequential maneuver of the pumps for 180 seconds, The order of pump operation can be programmed to inflate proximal to distal, distal to proximal, or both to enable lymph flow movement.

Table I. The sequential operation inflated the chambers one by one from proximal (upper arm) to distal (lower arm). The speed of each motor could be controlled from within the code. The speed was set such a way that the maximum pressure in a chamber did not exceed 60 mmHg [18]. With this setup, a time versus pressure curve was obtained as each chamber reached a pressure of 10, 20, 30, 40, and 50 mmHg. A voltage versus pressure curve was also obtained for each chamber. The order of pump operation can be programmed to inflate proximal to distal, distal to proximal, or both to enable lymph flow movement.

TABLE I
Duration of Operation for Sequential
Maneuver of Pumps.

| Total | | | | |
|---|---|---|---|---|
| Operation | Duration of Operation (Seconds) | | | |
| Time | Pump | Pump | Pump | Pump |
| (Seconds) | 1 | 2 | 3 | 4 |
| 180 | 180 | 150 | 120 | 90 |

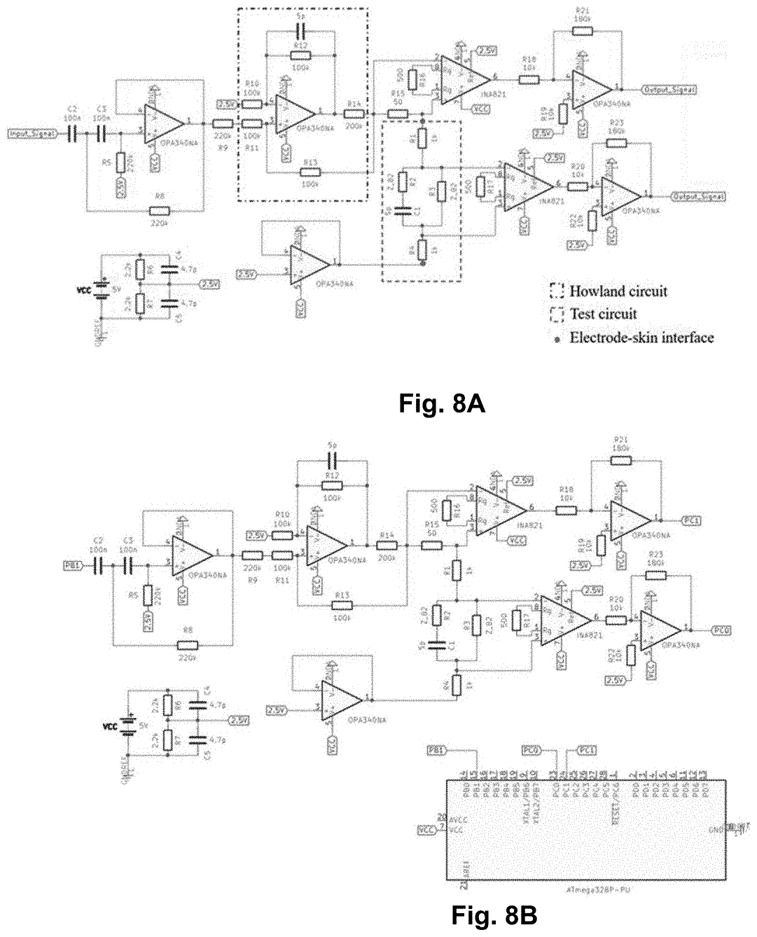

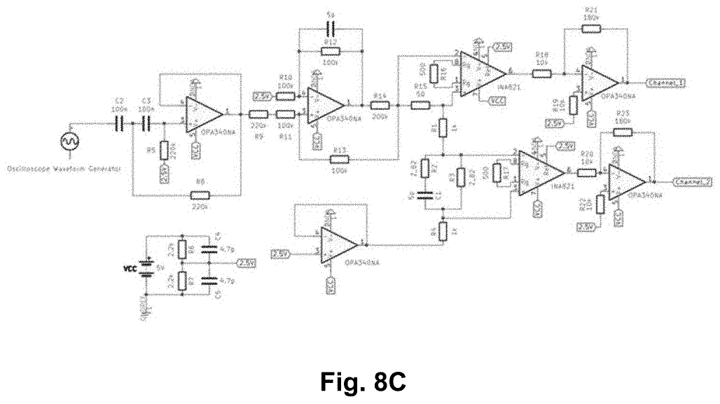

Design of BIA System—A BIA system was built to provide single frequency and multi frequency impedance measurement of a test circuit (equivalent to human arm model). The single frequency impedance measurement was performed to analyze the sensitivity of the system. The multi frequency impedance measurement was performed to obtain a semi-circular plot (Nyquist plot) that provides the resistance and reactance values for the test circuit for a frequency range of 100 Hz to 100 kHz. The accuracy of both single frequency and multi frequency measurements was validated by a calibrated LCR meter. The schematics of the systems are shown in FIG. 8B-8C.

Results—Table II shows the maximum pressure measured for each chamber for a compression duration of 180 seconds. The maximum pressure in the chambers ranged between 53.1 mmHg and 54 mmHg. It was observed that once reached, the maximum pressure was maintained by all four chambers throughout the duration of operation.

TABLE II
MAXIMUM PRESSURE MEASURED IN THE
CHAMBERS DURING SEQUENTIAL
OPERATION OF PUMPS.

| | Maximum | |
|---|---|---|
| Chamber | Pressure | Time to Reach |
| No. | (mmHg) | (Seconds) |
| Chamber 1 | 53.1 | 59 |
| Chamber 2 | 53.1 | 75 |
| Chamber 3 | 54.0 | 86 |
| Chamber 4 | 53.6 | 82 |

FIG. 10 shows the time required for individual chambers to reach 10, 20, 30, 40, and 50 mmHg of pressure. The average time required for the chambers to reach the first 50 mmHg pressure was 75 seconds.

FIG. 11 shows the voltage vs pressure curve for the chambers. The highest pressure of 117 mmHg was observed in chamber one for a 6 V supply whereas the lowest pressure of 6 mmHg was observed in chamber three for 4 V. All four chambers had a pressure range of 50 mmHg to 60 mmHg for a supply of 5 V.

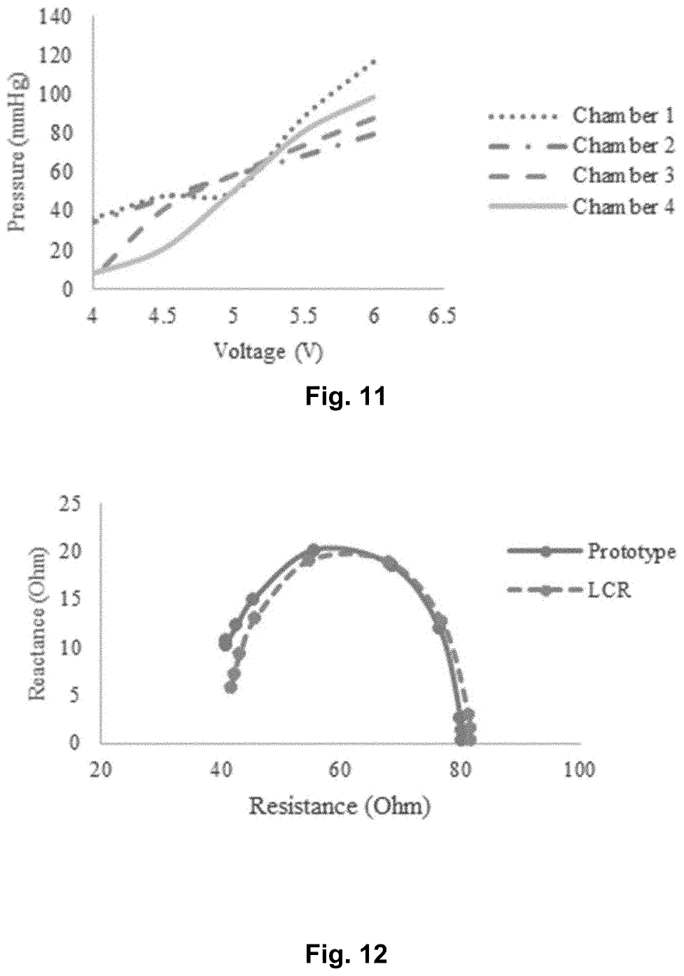

FIG. 12 shows the resistance and reactance values of the load circuit for a frequency range of 100 Hz to 100 kHz. As the frequency increased, the impedance values went from right to left, making a semi-circular shape (Nyquist plot).

Discussion

Pneumatic compression system—It was observed that the small pneumatic pumps selected, which are of suitable size for a fully portable device, could provide the pressure required during a timeframe that is reasonable and comparable to sequential compression routines in commercially available devices [52]. For a treatment duration of 180 seconds, pressure as high as 54 mmHg, which is greater than what is typically needed, was obtained. It was observed that once reached, the maximum pressure was maintained by all four chambers for the rest of the simulated treatment protocol. The average time required by the chambers (75 seconds) to reach maximum pressure allowed a steady inflation.

However, the voltage vs pressure data for the chambers suggested that the voltage input may not be a reliable way to determine the applied pneumatic pressure provided by small pumps, although the pressures were much more consistent at 5 V than at other voltages. A potential solution to this problem is the addition of pressure sensors and a feedback control system to regulate the applied pressure during compression therapy.

Duration of treatment could be varied as required through programming of the on-time and off-time of each pump. This would allow adjustments of the inflation time for each chamber [53]. The number of compression cycles (one full inflation and deflation of all four chambers) can be determined based on the treatment duration and recommended hours of treatment per day. Presumably a physician or licensed therapist would determine the treatment plan in conjunction with the available scientific evidence. A more localized compression can be achieved by increasing the number of chambers and changing their configurations [54]. Assessment can be made for an individual user to determine the pressure level for the chambers [22].

The heat sealable coated nylon fabric showed no signs of wear and tear after multiple tests. This makes the material a good candidate for use as compression chambers. No air leakage was observed during the experiments, suggesting that an impulse sealer is an effective tool for manufacturing the air chambers.

The compression system carrying the pumps, circuit, and batteries is portable (e.g. sized to fit in such as a fanny pack that goes around the waist of the person). This can enhance mobility by allowing freedom of movement. The lightweight, wearable sleeve can provide greater comfort during the course of the treatment in comparison to the more rigid materials of traditional compression garments.

B/A system—The Nyquist plot obtained for the prototype circuit was a close match with the one obtained from the LCR meter. It was observed that the capacitors and a high gain value (G=99.8) improved the CMRR performance of the circuit. The plot can provide information on total body water (TBW), extra-cellular fluid (ECF), and tissue mass. In particular, because the ECF measurement is a known diagnostic signal for lymphedema [26], and thus can serve as a useful signal for feedback control. In some embodiments, the data can be made accessible through a wireless connection.

Enough data can be accumulated to enable the application of dynamic systems feedback control with the human as part of the controlled plant, therefore enabling a precision medicine approach [27] to the management of lymphedema. Adaptive control laws or learning-based controllers may be applied to this human-in-the-loop system that can optimally manage the prescription of treatment. This system may be used to supplement the available data on the dynamic response of swelling with which to inform a model-based control system design.

In some embodiments, the BIA system can be integrated with the microcontroller for compression treatment. In order to accomplish this with a low power microcontroller, the high frequency test signals may be subsampled and the corresponding calculation of the Fourier coefficients shifted according to the frequency aliasing rules for sampling. The pumps will start operating upon the detection of swelling. Once the swelling goes down, sensors will detect the reduction and the pumps will stop.

In various embodiments, the compression sleeve can either be worn as an over-garment or be specially designed into ‘lymphedema shirts’ (or pants for lower extremity), eliminating the need to wear any additional garments. Such a garment can provide freedom of movement and reduce the discomfort associated with current devices. The ease of access to information regarding swelling condition over time may also help patients and their physicians better manage their lymphedema.

### Example 1 References

[1] S. G. Rockson, “Lymphedema,” Vasc. Med. (United Kingdom), vol. 21, no. 1, pp. 77-81, 2016.
[2] V. Velanovich and W. Szymanski, “Quality of life of breast cancer patients with lymphedema,” Am. J. Surg., vol. 177, no. 3, pp. 184-188, 1999.
[3] M. B. Tobin, H. J. Lacey, L. Meyer, and P. S. Mortimer, “The psychological morbidity of breast cancer-related arm swelling. Psychological morbidity of lymphoedema,” Cancer, vol. 72, no. 11, pp. 3248-3252, 1993.
[4] R. H. Zeissler, G. B. Rose, and P. A. Nelson, “Postmastectomy lymphedema: late results of treatment in 385 patients,” Arch. Phys. Med. Rehabil., vol. 53, no. 4, pp. 159-166, 1972.
[5] K. E. Rose, H. M. Taylor, and R. G. Twycross, “Long-term compliance with treatment in obstructive arm lymphoedema in cancer,” Palliat. Med., vol. 5, no. 1, pp. 52-55, 1991.
[6] OpenStax College, Anatomy and Physiology. 2013.
[7] L. Sherwood, “Human physiology from cells to systems Ninth Edition,” Appetite. Cengage Learning, 2016.
[8] S. Jamalian, M. J. Davis, D. C. Zawieja, and J. E. Moore, “Network Scale Modeling of Lymph Transport and Its Effective Pumping Parameters,” PLoS One, vol. 11, no. 2, 2016.
[9] R. M. Morrell, M. Y. Halyard, S. E. Schild, M. S. Ali, L. L. Gunderson, and B. A. Pockaj, “Breast cancer-related lymphedema,” Mayo Clinic Proceedings. Elsevier, pp. 1480-1484, 2005.
[10] A. K. Greene, “Epidemiology and morbidity of lymphedema,” in Lymphedema: Presentation, Diagnosis, and Treatment, Springer, Cham, 2015, pp. 33-44.
[11] K. Segerström, P. Bjerle, S. Graffman, and A. Nyström, “Factors that influence the incidence of brachial oedema after treatment of breast cancer,” Scand. J. Plast. Reconstr. Surg. Hand Surg., vol. 26, no. 2, pp. 223-227, 1992.
[12] R. H. Rönkä, M. S. Pamilo, K. A. J. Von Smitten, and M. H. K. Leidenius, “Breast lymphedema after breast conserving treatment,” Acta Oncol. (Madr)., vol. 43, no. 6, pp. 551-557, 2004.
[13] M. R. Fu et al., “L-Dex ratio in detecting breast cancer-related lymphedema: Reliability, sensitivity, and specificity,” Lymphology, vol. 46, no. 2, pp. 85-96, 2013.
[14] S. F. Khalil, M. S. Mohktar, and F. Ibrahim, “The theory and fundamentals of bioimpedance analysis in clinical status monitoring and diagnosis of diseases,” Sensors (Switzerland), vol. 14, no. 6, pp. 10895-10928, 2014.
[15] J. M. Armer, J. M. Hulett, M. Bernas, P. Ostby, B. R. Stewart, and J. N. Cormier, “Best-practice guidelines in assessment, risk reduction, management, and surveillance for post-breast cancer lymphedema,” Curr. Breast Cancer Rep., vol. 5, no. 2, pp. 134-144, 2013.
[16] D. S. C. Ko, R. Lerner, G. Klose, and A. B. Cosimi, “Effective treatment of lymphedema of the extremities,” Arch. Surg., vol. 133, no. 4, pp. 452-458, 1998.
[17] S. Buragadda, A. A. Alhusaini, G. R. Melam, and N. Arora, “Effect of complete decongestive therapy and a home program for patients with post mastectomy lymphedema,” J. Phys. Ther. Sci., vol. 27, no. 9, pp. 2743-2748, 2015.
[18] J. L. Feldman, N. L. Stout, A. Wanchai, B. R. Stewart, J. N. Cormier, and J. M. Armer, “Intermittent pneumatic compression therapy: A systematic review,” Lymphology, vol. 45, no. 1, pp. 13-25, 2012.
[19] J. J. Phillips and S. J. Gordon, “Intermittent pneumatic compression dosage for adults and children with lymphedema: A systematic review,” Lymphat. Res. Biol., vol. 17, pp. 2-18, 2019.
[20] M. Zaleska et al., “Pressures and timing of intermittent pneumatic compression devices for efficient tissue fluid and lymph flow in limbs with Lymphedema,” Lymphat. Res. Biol., vol. 11, no. 4, pp. 227-232, 2013.
[21] Centers for Medicare & Medicaid Services, “Local Coverage Determination (LCD): Pneumatic Compression Devices (L33829).” [Online]. Available: https://www.cms.gov/medicare-coverage-database/details/lcd-details.aspx?LCDId=33829&ver=42&Date=&DocD=L33829&bc=iAAAAAIAAAAA&.
[22] M. Zaleska, W. L. Olszewski, and M. Durlik, “The effectiveness of intermittent pneumatic compression in long-term therapy of lymphedema of lower limbs,” Lymphat. Res. Biol., vol. 12, no. 2, pp. 103-109, 2014.
[23] Bio Compression Systems Inc., “Model SC-3004 Sequential Circulator.” [Online]. Available: https://www.biocompression.com/model-sc-3004-sequential-circulator/.
[24] R. Scheer, “Compression garments for managing lymphoedema,” J. Lymphoedema, vol. 12, no. 1, pp. 39-45, 2017.
[25] Y. Xiong and X. Tao, “Compression garments for medical therapy and sports,” Polymers (Basel)., vol. 10, no. 6, p. 663, 2018.
[26] Impedimed, “Bioimpedance spectroscopy (BIS) technology.” [Online]. Available: https://www.impedimed.com/healthcare/bis-technology/.
[27] K. E. Adams et al., “Direct evidence of lymphatic function improvement after advanced pneumatic compression device treatment of lymphedema,” Biomed. Opt. Express, vol. 1, no. 1, p. 114, 2010.
[28] S. Muluk and E. Taffe, “A Review of Pneumatic Compression Therapy in the Treatment of Lymphedema,” SM Vasc Med., vol. 1, no. 1, p. 1003, 2016.
[29] G. Pettinico and G. R. Milne, “Living by the numbers: understanding the ‘quantification effect,’” J. Consum. Mark., 2017.
[30] N. P. Reddy, T. A. Krouskop, and P. H. Newell, “A computer model of the lymphatic system,” Comput. Biol. Med., vol. 7, no. 3, pp. 181-197, 1977.
[31] R. E. Drake, S. J. Allen, J. Katz, J. C. Gabel, and G. A. Laine, “Equivalent circuit technique for lymph flow studies,” Am. J. Physiol.—Hear. Circ. Physiol., vol. 251, no. 5, pp. H1090-H1094, 1986.
[32] C. D. Bertram, C. Macaskill, M. J. Davis, and J. E. Moore, “Development of a model of a multi-lymphangion lymphatic vessel incorporating realistic and measured parameter values,” Biomech. Model. Mechanobiol., vol. 13, pp. 401-416, 2014.
[33] U. Pilch, M. Wozniewski, and A. Szuba, “Influence of compression cycle time and number of sleeve chambers on upper extremity lymphedema volume reduction during intermittent pneumatic compression,” Lymphology, vol. 42, no. 1, pp. 26-35, 2009.
[34] M. Miguel, M. Leite, A. M. R. Ribeiro, A. M. Deus, L. Reis, and M. F. Vaz, “Failure of polymer coated nylon parts produced by additive manufacturing,” Eng. Fail. Anal., vol. 101, pp. 485-492, 2019.
[35] R. A. Maclellan, Pneumatic compression. Springer, Cham, 215AD.
[36] M. F. Cheng, Y. Y. Chen, T. R. Jang, W. L. Lin, J. Chen, and K. C. Hsieh, “Total body composition estimated by standing-posture 8-electrode bioelectrical impedance analysis in male wrestlers,” Biol. Sport, vol. 33, no. 4, p. 399, 2016.
[37] B. Ibrahim, D. A. Hall, and R. Jaffari, “Bio-impedance spectroscopy (BIS) measurement system for wearable devices,” in IEEE Biomedical Circuits and Systems Conference (BioCAS), 2017, pp. 1-4.
[38] “Electrical theory behind the measurement of body fluids with bioimpedance spectroscopy (BIS).” [Online]. Available: https://pure.au.dk/portal/files/20320521/lecture_notes_on_bis.pdf.
[39] “500 kHz/1 MHz Precision LCR Meter.” [Online]. Available: https://bkpmedia.s3.amazonaws.com/downloads/datasheets/en-us/894_895_datasheet.pdf.
[40] M. Y. Jaffrin and H. Morel, “Body fluid volumes measurements by impedance: A review of bioimpedance spectroscopy (BIS) and bioimpedance analysis (BIA) methods,” Med. Eng. Phys., vol. 30, no. 10, pp. 1257-1269, 2008.
[41] L. Kim, J. Y. Jeon, I. Y. Sung, S. Y. Jeong, J. H. Do, and H. J. Kim, “Prediction of Treatment Outcome with Bioimpedance Measurements in Breast Cancer Related Lymphedema Patients,” Ann. Rehabil. Med., vol. 35, no. 5, pp. 687-693, 2011.
[42] H. Yazdanian, M. M. Samani, and A. Mahanm, “Characteristics of the Howland current source for bioelectric impedance measurements systems,” in 2013 20th Iranian Conference on Biomedical Engineering, ICBME 2013, 2013, pp. 189-193.
[43] Texas Instruments, “INA821 Datasheet.” [Online]. Available: https://www.ti.com/document-viewer/INA821/datasheet/features-sbos7928252#SBOS7928252.
[44] Texas Instruments, “OPA340 Datasheet.” [Online]. Available: https://www.ti.com/document-viewer/OPA340/datasheet.
[45] R. Chandler, G; Denson, W.; Rossi, M.; Wanner, “Failure Mode/Mechanism Distributions,” 1991.
[46] “Arduino Uno Rev3.” [Online]. Available: https://store.arduino.cc/usa/arduino-uno-rev3.
[47] “8-bit AVR Microcontroller with 32K Bytes In-System Programmable Flash.” [Online]. Available: http://ww1.microchip.com/downloads/en/DeviceDoc/Atmel-7810-Automotive-Microcontrollers-ATmega328P_Datasheet.pdf.
[48] A. S. N. Mokhtar, M. I. Ayub, N. Ismail, and N. G. N. Daud, “Implementation of trigonometric function using CORDIC algorithms,” in AIP Conference Proceedings, 2018, p. 020040.
[49] W. Elmenreich, M. Rosenblattl, and A. Wolf, “Fixed point library based on ISO/IEC standard DTR 18037 for Atmel AVR microcontrollers,” in Proceedings of the 5th International Workshop on Intelligent Solutions in Embedded Systems, WISES 7, 2007, pp. 101-113.
[50] “Average human height by country.” [Online]. Available: https://en.wikipedia.org/wiki/Average_human_height_by_country.
[51] “Human body weight.” [Online]. Available: https://en.wikipedia.org/wiki/Human_body_weight.
[52] Biocompression, “Model SC-2004-OC Sequential Circulator I Bio Compression Systems, Inc.” [Online]. Available: https://www.biocompression.com/model-sc-2004-oc-sequential-circulator/.
[53] M. Zaleska et al., “Pressures and timing of intermittent pneumatic compression devices for efficient tissue fluid and lymph flow in limbs with Lymphedema,” Lymphat. Res. Biol., vol. 11, no. 4, pp. 227-232, 2013.
[54] C. J. Chang and J. N. Cormier, “Lymphedema Interventions: Exercise, Surgery, and Compression Devices,” Semin. Oncol. Nurs., vol. 29, no. 1, pp. 28-40, 2013.
[55] S. Hayes, M. Janda, B. Cornish, D. Battistutta, and B. Newman, “Lymphedema secondary to breast cancer: How choice of measure influences diagnosis, prevalence, and identifiable risk factors,” Lymphology, vol. 41, no. 1, pp. 18-28, 2008.
[56] F. S. Collins and H. Varmus, “A new initiative on precision medicine,” N. Engl. J. Med., vol. 372, no. 9, pp. 793-795, 2015.

### Example 2

Further discussion and details are provided in “A FEEDBACK-BASED PNEUMATIC COMPRESSION SYSTEM FOR EFFECTIVE LYMPHEDEMA MANAGEMENT”, Masters Thesis, I. M. Kayes, Louisiana State University, October 2020, which is incorporated by reference herein in its entirety.

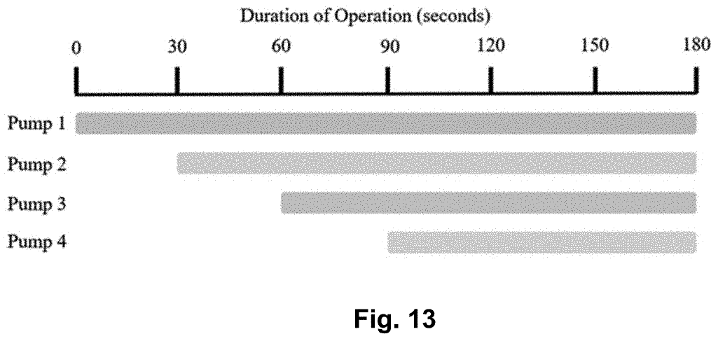

Sequential Operation of Pumps—A compression circuit system was built for a sequential maneuver of the pumps for a total duration of 180 seconds that indicated one full compression cycle (FIG. 13). The compression cycle was divided into four phases. Phase 1 denoted the operation of Pump 1 from 0 to 30 seconds. Phase 2 denoted the operation of Pump 1 and Pump 2 from 30 to 60 seconds. Phase 3 denoted the operation of the first three pumps from 60 to 90 seconds and Phase 4 denoted the operation of all four pumps from 90 to 180 seconds.

The sequential operation inflated the chambers one by one from proximal (upper arm) to distal (lower arm) with the maximum pressure in a chamber not to exceed 60 mmHg [35]. With this setup, a time versus pressure curve was obtained as each chamber reached a pressure of 10, 20, 30, 40, and 50 mmHg. A voltage versus pressure curve was also obtained for the chambers.

BIA SUBSYSTEM—Performing a BIA analysis typically includes a hand-to-hand mode or a foot-to-foot mode in which the path of current flows through respective limbs [36]. The procedure involves attaching a number of contact electrodes to measure body impedance values. By combining hand and foot contact plates with a fixed measuring circuit, a multi-segmental impedance measurement system can also be developed for a BIA analysis.

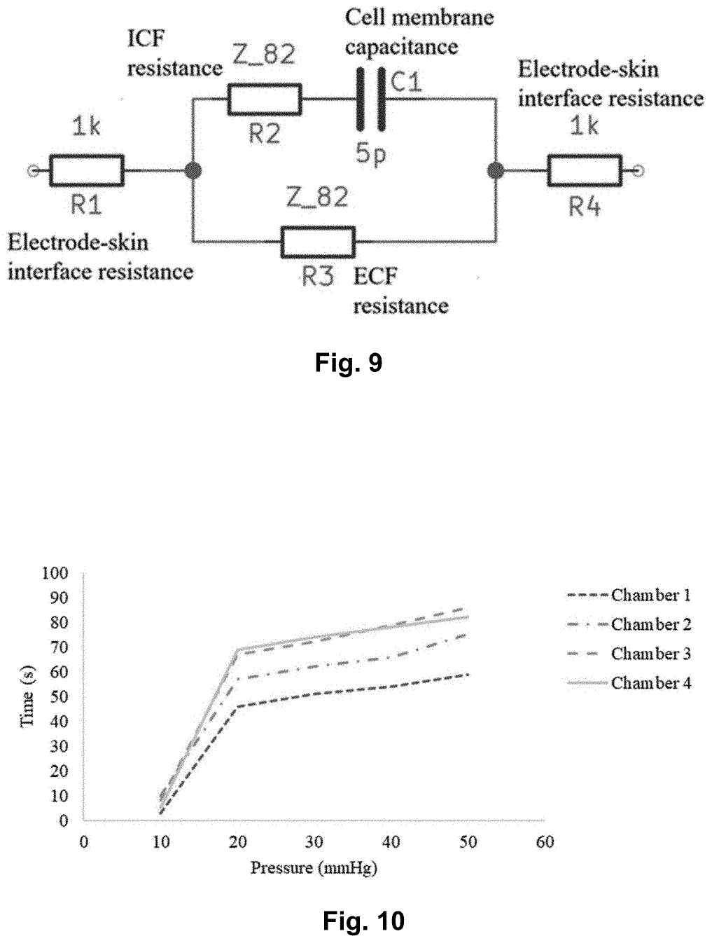

Development of Test Circuit—A test circuit equivalent to the human arm model was developed as a part of designing the BIA subsystem, FIG. 9 [37]. Resistors R1 and R4 modeled the resistance of the electrode-skin interface. Resistors R2 and R3 modeled the intra-cellular fluid (ICF) and extra-cellular fluid (ECF) respectively and are mentioned as the ‘test circuit impedance’ throughout this study. The cell membrane capacitor C1 was in series with ICF resistor R2 and parallel with ECF resistor R3.

The test circuit impedance is a frequency-dependent variable impedance with a resistive (real) part and a reactive (imaginary) part. At very low frequency, the cell membranes act as an effective barrier to AC current that makes the current to pass around the cell membranes. For a very high frequency, the current passes directly through the cell membrane and no capacitance is observed. At medium range frequencies, the cell membranes act as capacitors and the phase differences between the current intensity and voltage drop are observed. In practice, the phase difference for biological tissues are typically below 10 degrees or 0.17 rad [38].

For the BIA subsystem, an initial test circuit included an ECF and ICF impedance of 82Ω (denoted by Z82). Measured at zero frequency with a calibrated LCR meter (B&K Precision Model 894, Yorba Linda, California, USA) [39], the actual DC resistance for Z82 was 81.81Ω. Measured in the limit as frequency increases, the test circuit impedance theoretically decreases to a limiting value of 41Ω. Practically, parasitic effects mean that at extremely high frequencies, inductive effects take over, increasing the total impedance. The change in impedance with varying frequency was measured with the LCR meter.

Relationship between ECF Volume and ECF Resistance—The relationship between ECF volume [symbol] (V [symbol] _ECF) and ECF resistance (or in this case, test circuit impedance) (Z) can be given by the following equation [38], [40]

$${V}_{ECF} = {{k}_{EFC} ( \frac{{H}^{2} \sqrt{W}}{Z} )}^{2 / 3}$$

where H and W are the height and weight of the individual expressed in cm and kg respectively. The factor k_{ECF} depends on ECF resistivity (ρ_{ECF}) expressed in Ω-cm, and body density (D_{b}) expressed in

$$\frac{g}{{cm}^{3}} .$$

The value of k_{ECF} can be further calculated by the following equation

$${k}_{ECF} = \frac{1}{100} {( \frac{{K}_{B}^{2} {ρ}_{ECF}^{2}}{{D}_{b}} )}^{2 / 3}$$

where K_{B} is a factor based on approximation of individual geometry. For measurements of V_{ECF}, k_{ECF} can be approximated as 0.306 for men and 0.316 for women [40]. A 3% change in V_{ECF} can be an indication of lymphedema related swelling [41].

Development of B/A Circuit—A BIA circuit was built to provide single and multi-frequency impedance measurements of the test circuit, FIG. 8A. The circuit performance was simulated using TINA-TI analog electronic circuit simulator.

A virtual ground circuit was used to create a mid-supply rail, consisting of a resistor divider and op-amp follower (OPA 340, Texas Instruments) in a unity gain configuration. Thus, for the signal conditioning circuitry, the power supply system consisted of a high-side supply of +2.5 V and a low-side supply of −2.5 with the virtual ground in between. The 5 V power input was provided by a Zeee 5200 mAh 7.4 V battery (Zeee Power, Houizhou, Guangdong, China).

An OPA 340 op-amp was used as the basis of a Howland current source circuit in the BIA subsystem. The positive and negative feedback paths of the Howland circuit were balanced through a matched resistor array consisting of four resistors (R11 to R13) of 100 kΩ (ORNTA1003AT1, Vishay Intertechnology) with a precision of ±0.1%. As a result, a voltage-controlled current source was obtained [42]. A resistor of 500Ω was placed across the Rg pins (R16 and R17) of the in-amps to achieve a differential gain of G=99.8, [43]. This gain value was used to achieve a high common-mode rejection ratio (CMRR) which can be represented by the following equation:

$$CMRR = ( \frac{{A}_{d}}{\vert {A}_{CM} \vert} ) = 10 {{log}_{10} ( \frac{{A}_{d}}{\vert {A}_{CM} \vert} )}^{2} dB = 20 {log}_{10} ( \frac{{A}_{d}}{\vert {A}_{CM} \vert} ) dB$$

Here, A_{d} is the differential gain (G) and A_{CM} is the common-mode gain. Hence, a high value for A_{d} ensured the amplification of required differential signals while rejecting unwanted common-mode signals. A final gain stage was implemented with an inverting amplifier (OPA 340) with a gain of 18 [44]. Two instrumentation amplifiers (INA 821, Texas Instruments) measured the output voltage drops across both the test circuit impedance (Z₈₂) and a known reference impedance (R15) of 50Ω placed in series with the test circuit impedance.

The maximum voltage that could be supplied to the circuit was limited by the 7.4 V voltage of the battery. The use of a 200 kΩ resistor (R14) reduced the possibility of a large current development in the test circuit. Moreover, a very low probability of short-circuit failure mode for film type resistors [45] enhanced the safety features of the circuit.

BIA Subsystem for Single Frequency Impedance Measurement

Configuration of Microcontroller as Signal Generator—An Arduino UNO Rev3 microcontroller board based on an 8-bit ATmega328P-PU microcontroller was used to generate a pulse-width modulation (PWM) signal for the BIA circuit in a ‘Phase and Frequency Correct’ mode [46], [47], Error! Reference source not found. The PWM signal frequency (f_{PWM}) was calculated by using the following equation:

$${f}_{PWM} = \frac{{f}_{CLK}}{2 \times {N}_{p} \times TOP}$$

Here, f_{CLK} is the 16 MHz clock frequency of the microcontroller, Nₚ is the prescaler divider value and TOP is the timer/counter top set in the Input Capture Register 1 (ICR1) of the microcontroller. With the 16-bit timer, the highest TOP value of 0xFFFF or 65536 was obtained from ICR1. For a presecaler divider (Nₚ) value of 1, a 122.7 Hz PWM frequency (f_{PWM}) was obtained.

The hexadecimal representation of the final fuse configuration for the microcontroller is given by the following: Low—0xBF; High—0xDE; Extended—0x05

The internal 10-bit analog-to-digital converter (ADC) of the microcontroller was used to convert the analog signal into a digital signal. The analog input pin PC0 of the microcontroller recorded the voltage drop across the test circuit impedance whereas the analog input pin PC1 recorded the voltage drop across the reference impedance.

Calculating Fourier Coefficients of Signal Frequency—The Fourier coefficient for a measured signal x(t) sampled at times iΔt, (i=1, . . . , N) can be approximated by the following rectangular-windowed discrete transform:

$${c}_{N} = \frac{2}{N} {\sum }_{i = 1}^{N} ( cos ( 2 π {f}_{b} i Δ t ) + i sin ( 2 π {f}_{b} i Δ t ) ) \times ( i Δ t )$$

In the above equation, the number of samples N was selected as

N∈{100,200,500,1000,2000,5000}
for the calculation of Fourier coefficient. The number of samples is a tradeoff between the time to finish the measurement and the accuracy. Considering a partial sum to find a recursive algorithm for computation of c_{N}, the Fourier coefficient was calculated as—

$$\begin{matrix}{c}_{j} = \frac{2}{j} ( \frac{j - 1}{2} {c}_{j - 1} + ( cos ( 2 π {f}_{b} j Δ t ) + i sin ( 2 π {f}_{b} j Δ t ) ) \times ( j Δ t ) ) \\ = \frac{j - 1}{j} {c}_{j - 1} + \frac{2}{j} ( cos ( 2 π {f}_{b} j Δ t ) + i sin ( 2 π {f}_{b} j Δ t ) ) \times ( j Δ t )\end{matrix}$$

The Coordinate Rotation Digital Computer (CORDIC) algorithm was used to calculate trigonometric functions in the above Fourier coefficients formula [48]. With the time sampling interval (Δt) set at 25 ρs, the algorithm was formulated to calculate the Fourier coefficient of the PWM signal frequency of 122.7 Hz and a sampling frequency of 500 Hz. A total of 20 measurements were obtained for each number of samples (N).

A fixed-point arithmetic was used for the ATmega328P-PU microcontroller to perform required computations and ensure that calculations can be performed at the required sample rates [47]. A fixed-point arithmetic library, AVRfix was used for all fixed-point calculations. Based on the ISO/IEC 18037 standard, the signed_Accum s15.16 bit fixed-point data type was used for calculations[49].

Calculations of Ratio of Amplitudes and Phase Difference between Output Signals—The output of the discreet Fourier transform algorithm consists of a real part (Re) and an imaginary part (Im). The ratio of amplitude of the output signals (γ) was calculated by using the following equations—

$$\begin{matrix}Amplitude of output signal \\ signal obtained from analog input pin PC 0 ( {γ}_{1} ) = \sqrt{{( Re )}_{1}^{2} + {( Im )}_{1}^{2}}\end{matrix}$$

$$\begin{matrix}Amplitude of output signal \\ signal obtained from analog input pin PC 1 ( {γ}_{2} ) = \sqrt{{( Re )}_{2}^{2} + {( Im )}_{2}^{2}}\end{matrix}$$

$$Ratio of amplitude ( γ ) = \frac{{γ}_{1}}{{γ}_{2}}$$

The phase difference (ϕ) between the two output signals was also obtained by using the following equations—

$$\begin{matrix}Phase of output signal obtained \\ from analog input pin PC 0 ( {Φ}_{1} ) = atan ( \frac{{Im}_{1}}{{Re}_{1}} )\end{matrix}$$

$$\begin{matrix}Phase of output signal obtained \\ from analog input pin PC 0 ( {Φ}_{2} ) = atan ( \frac{{Im}_{2}}{{Re}_{2}} )\end{matrix}$$

$$Phase difference ( Φ ) = \vert {Φ}_{1} - {Φ}_{2} \vert$$

Using the above equations, the mean values of ratio of amplitudes (γ) and phase difference (ϕ) were obtained for the specified number of samples (N). The accuracy of measurements was estimated based on a 95% confidence interval for the 20 data points.

Comparison between Test Circuit Impedance and Measured Impedance in single frequency BIA measurement—The ratio of output signal amplitudes (γ) was multiplied by the reference impedance (50Ω) to measure the impedance of the body (or, in this case, a phantom test circuit). To compare the measured impedance with the test circuit impedance, the following set of nine variable test circuit impedance (measured by a high accuracy LCR meter at zero frequency) were considered for the BIA subsystem along with the initial impedance of Z₈₂:

| Denote | Z₇₄ | Z₇₆ | Z₇₈ | Z₈₀ | Z₈₂ | Z₈₄ | Z₈₆ | Z₈₈ | Z₉₀ |
|---|---|---|---|---|---|---|---|---|---|
| Z (Ω) | 74.5 | 75.95 | 77.78 | 80.22 | 81.81 | 83.56 | 86.6 | 88.21 | 90.34 |

For each of the nine test circuit impedances, the standard value of ratio of amplitude (γ) was calculated based on the 50Ω reference impedance. A percentage of error between the test circuit impedance and the measured impedance was obtained for specified number of samples (N). The percentage of error was averaged over N to get the error range for all nine test circuit impedance values.

Sensitivity Analysis of Measured Impedance—The percentage of error between the test circuit impedance and the measured impedance was used to analyze the sensitivity of the BIA circuit. For an average percentage of error in measured impedance, the corresponding error in ECF volume was calculated based on equations (7) and (8). The range of error was then used to determine the sensitivity of the BIA circuit that could be used for detection of swelling.

BIA Subsystem for Multi Frequency Impedance Measurement

Multiple Frequency Testing—A Mixed Signal Oscilloscope (Keysight InfiniiVision MSOX3024T) was used to capture the output signals from the two instrumentation amplifiers, Error! Reference source not found. The oscilloscope's built-in waveform generator was set to generate square waves of frequencies

f={100,500,1k,5k,10k,20k,40k,60k,80k,100k}Hz

across the inputs to the Howland circuit.

Channel 1 of the oscilloscope measured the voltage drop across the reference impedance (50Ω) whereas Channel 2 measured the voltage drop across the test circuit impedance (Z₇₄ to Z₉₀).

Generation of Nyquist Plot—The waveform data obtained from oscilloscope was imported to MATLAB and the Fourier coefficients of the periodic voltage measurements of the test circuit resistance at frequency fᵢ, labeled Rᵢ, and the test circuit reactance at frequency fᵢ, labeled Xᵢ, were calculated at each of the test frequencies to generate the Nyquist plot. The MATLAB trapezoidal numerical integration method was used to calculate the Fourier coefficients for signals obtained from Channel 1 and Channel 2 of the oscilloscope with a sampling time dt=8×10⁻¹⁰ seconds. The following equations describe the calculation, where τ is the signal period.

$${A}_{i} = {\int }_{0}^{{N}_{τ}} {e}^{j {ω}_{i} t} {V}_{ref} ( t ) dt$$

$${B}_{i} = {\int }_{0}^{{N}_{τ}} {e}^{j {ω}_{i} t} {V}_{test} ( t ) dt$$

$${ω}_{i} = 2 π {f}_{i}$$

$${R}_{i} + {jX}_{i} = \frac{{B}_{i}}{{A}_{i}} {R}_{ref}$$

The Nyquist plot was validated by using the calibrated LCR meter that measured the resistance and reactance of the test circuit at the same signal frequencies with 4-wire Kelvin clips. A comparison was made between the prototype BIA measurements and LCR meter measurements of test circuit impedance at room temperature (72 F) over the specified frequency range. The comparison was based on the ‘Magnitude Ratio’ that can be calculated by the following equation:

$$Magnitude ratio ( m ) = \frac{Test circuit impedance magnitude obtained from protype}{Test circuit impedance magnitude meausred by LCR meter}$$

Temperature Stability—The temperature stability of the BIA circuit was examined to observe changes in the Nyquist plot for test circuit impedance Z74 at temperatures higher than the room temperature (72 F) to simulate potential variability in the environment of the measurement device. A hot plate was used to slowly heat the BIA circuit until the temperature reached the target values of T={75,80,85,90} F. Once the target temperature was reached, the oscilloscope was used to obtain waveform data. Voltage drops across the reference impedance and the test circuit impedance were captured to generate Nyquist plots similar to the previously described method.

Calculation of Battery Life and Number of Compression Cycles—Both the compression subsystem and the BIA subsystem were powered by a Zeee 5200 mAh 7.4 V battery. For the compression subsystem, the four phases (p=1, 2, 3, 4) contributed to the average current draw over one compression cycle of 180 seconds. An ammeter was used to measure the average current draw at each of the four phases. The weighted average for compression subsystem (I_{avg-compression}) was calculated by the following equation—

$${I}_{avg - compression} = \frac{{\sum }_{p = 1}^{4} {I}_{p} \times {T}_{p}}{180}$$

where Iₚ is the average current draw by phase p and Tₚ is the duration of phase p.
For the BIA subsystem, the Arduino board (I_{avg-arduino}), microcontroller (I_{avg-microcontroller}), and Howland circuit (I_{avg-Howland}) contributed to the average current draw (I_{avg-BIA}) over one compression cycle of 180 seconds. The weighted average was calculated by the following equation—

I_{avg-BIA}=I_{avg-arduino}+I_{avg-microcontroller}+I_{avg-Howland}

The average power draw by the compression subsystem and the BIA subsystem was calculated based on the average current draw over one compression cycle by those subsystems and the supply voltage. The battery life was calculated based on the battery capacity and the total average power draw over one compression cycle by the subsystems. The estimated total number of compression cycles was calculated based on the battery life and the duration of each compression cycle.

### Example 3

To illustrate the mechanism by which the BIS feedback enables control decisions, we consider a simplified model of the system. The affected limb may be considered as a lumped hydraulic capacitance. The arm is used as a non-limiting example here. The inflow to the arm capacitance is assumed to be uniform at a rate of approximately 10 cc/hr, which matches the normal lymph flow volume of 250 mL/day. An approximate model of the arm as a fluid volume contained within a right cylindrical shell with an initial volume of approximately V₀=2,500 cm³ (Clauser, McConville, and Young 1969), a wall thickness of t_{w}≈1 cm, an initial radius r₀≈4 cm based on the average female arm length of 55 cm (Watts et al. 2020), and with the wall made of tissues with Young's modulus E≈1 MPa. Treating the skin and subcutaneous tissues as a bladder that can expand with increasing volume due to extra extracellular fluid, the hydraulic capacitance is given by

$${C}_{h} = \frac{2 {r}_{0} {V}_{0}}{{t}_{w} E} = 0.002 \frac{{cm}^{3}}{dyn \cdot {cm}^{- 2}}$$

Define the increment of volume ΔV such that the actual volume is V=V₀+ΔV. Then the relationship between the change in pressure ΔP=Pₐ−Pₐ₀, which is the difference between the interstitial hydrostatic pressure and its operating point value, and the increment of volume is given as follows (Karnopp, Margolis, and Rosenberg 2012).

$$Δ P = \frac{Δ V}{{C}_{h}}$$

The conservation of fluid volume is applied under the assumption of incompressible fluid.

ΔV=∫₀^{t}Qᵢₙ−Qₒᵤₜdt

The normal inflow from the capillaries, Qᵢₙ, is approximately 4 L/day for most humans, considering the whole volume. (Moore and Bertram 2018). Taking for example the arm as a single hydraulic volume, the inflow may be approximated as 6% of the total given that the arm accounts for about 6% of total body mass (Clauser, McConville, and Young 1969). The outflow Qₒᵤₜ accounts for the fluid removed from the interstitial space by the lymphatic system.

The network of lymphatic vessels consisting of the initial lymphatics, precollectors, prenodal collecting lymphatics, lymph nodes, postnodal collecting lymphatics, and the larger trunks that connect to the subclavian veins form a pumping system that moves fluid against a hydrostatic pressure gradient. In the case of the arm, interstitial fluid pressures are just below atmospheric pressure and the lymphatic system outflow must be at approximately 20 cmH₂O (Breslin 2014; Moore and Bertram 2018). Note that if there is a hydraulic resistance to flow at any intermediate point, the hydrostatic pressures may rise above the overall system outflow pressure, such as if the axillary nodes are damaged and present a high resistance to flow.

A model of the dynamic system treats the lymphatic system components as a combination of a pressure source and a hydraulic resistance. This simplified view ignores the dynamics of the individual lymphangions, such as modeled by complex dynamic network models (Bertram et al. 2014), and instead considers the linear system approximation which is valid only on long time scales and for small changes in the hydraulic volumes and pressures. The linear systems theory then allows the representation of the lymphangion network as a series combination of a hydraulic pressure source (a pump) and a hydraulic resistance.

−Pₒᵤₜ+(Pₐ₀+ΔP)+Pₚᵤₘₚ−QₒᵤₜRₕ=0

A change in the pump effectiveness due to the presence of an external compression therapy device is modeled as a change in the value of Pₚᵤₘₚ, given by ΔPₚᵤₘₚ. Then, we have

$$Δ {Q}_{out} = \frac{Δ {P}_{pump}}{{R}_{h}} - \frac{Δ V}{{R}_{h} {C}_{h}}$$

Then, we find a first-order dynamic model for the system:

$$\frac{d}{dt} Δ V + \frac{Δ V}{{R}_{h} {C}_{h}} = \frac{Δ {P}_{pump}}{{R}_{h}}$$

The solutions to this equation have an exponential decay to a steady value of ΔV.

ΔV(t)=CₕΔPₚᵤₘₚ(1−exp(−t/RₕCₕ))

Given especially that changes in lymph flows are observable in real-time during the application of pneumatic compression on the skin (Kitayama et al. 2017), changes in the value of ΔV will be observable on a time scale ranging from minutes to hours after the beginning of a compression therapy session. Although the values of Rₕ and Cₕ may both change over long time scales a result of growth and remodeling processes within the body, they should not be expected to change markedly on a timescale of minutes to hours.

With a BIS device integrated into the compression therapy device to measure the change in volume ΔV directly due to the addition or removal of extracellular water, the time constant T=RₕCₕ can be measured through the application of a least-squares regression, which takes subsequent measurements in time ΔV(tₖ). After assembling the regressor matrix ϕ which has row k given by

ϕₖ=[−ΔV(tₖ),1]

and the vector of scalar observations y given in terms

$${y}_{k} = \frac{1}{{t}_{k} - {t}_{k - 1}} ( Δ V ( {t}_{k} ) - Δ V ( {t}_{k - 1} ) )$$

Then, the approximate value of τ and the input are provided by the solution to the least-squares regression problem

$$[ \begin{matrix}{\hat{τ}}^{- 1} \\ \hat{Q}\end{matrix} ] = {( {Φ}_{k}^{T} {Φ}_{k} )}^{- 1} {Φ}^{T} y$$

For the purpose of implementing this equation in a low-cost microcontroller-based device, the well-known recursive formulation of the least squares estimator may be used (Åström and Wittenmark 2013).

The controller may then be programmed to evaluate whether a compression therapy session is complete by comparing the elapsed time since the start of the program to a multiple of τ as estimated by the least-squares program. For example, the stopping criterion can be when the elapsed time t>3τ, at which time the reduction in volume is expected to be approximately 95% of what is possible within a single compression therapy session. For the purposes of safety and efficacy, the criterion may be modified as follows:

STOP if (t>3τΛt>tₘᵢₙ) OR t>tₘₐₓ

where tₘᵢₙ and tₘₐₓ are physician programmable values indicating the minimum and maximum permissible treatment times.

In addition to providing a stopping criterion, the values of τ and Q may both be recorded at the end of the compression therapy session to serve as indications of the treatment effectiveness, which may be monitored by both the patient and the physician over the course of treatment for the chronic disease. The information contained in these values is related to the lumped hydraulic resistance, hydraulic capacitance, and maximum achievable limb volume change which are estimated during a single session of compression therapy. Since hydraulic capacitance is mainly related to the initial volume of the limb and the elastic properties of the solid tissue components, and since the hydraulic resistance is related primarily to the tissue properties and structure, these values may change as the disease progresses or is ameliorated by therapy.

### Example 3 References

Åström, Karl J., and Björn Wittenmark. 2013. Adaptive Control. Courier Corporation.
Bertram, C. D., C. Macaskill, M. J. Davis, and J. E. Moore. 2014. “Development of a Model of a Multi-Lymphangion Lymphatic Vessel Incorporating Realistic and Measured Parameter Values.” Biomechanics and Modeling in Mechanobiology 13 (2): 401-16.
Breslin, Jerome W. 2014. “Mechanical Forces and Lymphatic Transport.” Microvascular Research 96: 46-54.
Clauser, Charles E., John T. McConville, and J. W. Young. 1969. “Weight, Volume, and Center of Mass of Segments of the Human Body.” AMRL-TR-69-70. Wright-Patterson AFB, OH: Air Force Systems Command.
Karnopp, Dean C, Donald L Margolis, and Ronald C Rosenberg. 2012. System Dynamics: Modeling, Simulation, and Control of Mechatronic Systems. 5th ed. Hoboken: John Wiley & Sons, Inc.
Kitayama, Shinya, Jiro Maegawa, Shinobu Matsubara, Shinji Kobayashi, Taro Mikami, Koichi Hirotomi, and Shintaro Kagimoto. 2017. “Real-Time Direct Evidence of the Superficial Lymphatic Drainage Effect of Intermittent Pneumatic Compression Treatment for Lower Limb Lymphedema.” Lymphatic Research and Biology 15 (1): 77-86.
Moore, James E, Jr, and Christopher D Bertram. 2018. “Lymphatic System Flows.” Annual Review of Fluid Mechanics 50 (January): 459-82. https://doi.org/10.1146/annurev-fluid-122316-045259.
Watts, Krista, Phoenix Hwaung, James Grymes, Samuel H. Cottam, Steven B. Heymsfield, and Diana M. Thomas. 2020. “Allometric Models of Adult Regional Body Lengths and Circumferences to Height: Insights from a Three-Dimensional Body Image Scanner.” American Journal of Human Biology 32 (3): e23349. https://doi.org/10.1002/ajhb.23349.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A compression device comprising:
a sleeve comprising a plurality of inflatable chambers;
at least one pneumatic pump coupled to at least one inflatable chamber;
a portable bio impedance analyzer;
a microcontroller; and
a battery;
wherein the battery powers the microcontroller and the at least one pneumatic pump and wherein the microcontroller controls the portable bio impedance analyzer and the at least one pneumatic pump.

2. The compression device of claim 1, wherein the portable bio impedance analyzer comprises at least one sensor and a bio impedance circuit, wherein the bio impedance circuit sends signals to and receives signals from a user's skin.

3. The compression device of claim 1, wherein the at least one pneumatic pump, the portable bio impedance analyzer, the microcontroller, and the battery are contained within a wearable pack.

4. The compression device of claim 1, further comprising at least one pressure sensor that senses the pressure inside at least one inflatable chambers.

5. The compression device of claim 1, wherein the inflatable chambers are inflated sequentially, and wherein the pressure and the duration of the inflation is controlled in response to data received from the portable bio impedance analyzer.

6. The compression device of claim 1, wherein the pressure in each inflatable chamber can be the same as or can be different from one another, and wherein the maximum pressure in each inflatable chamber can be about or about 0 to about 60 mmHg.

7. The compression device of claim 1, wherein the at least one pneumatic pump is a 4.5 V DC-motor-driven gas diaphragm pump.

8. The compression device of claim 1, wherein the microcontroller is in wireless communication with a computing device.

9. The compression device of claim 2, wherein the signals are measurements of one or more of total body water, extra-cellular fluid, intra-cellular fluid, fat mass, and fat free mass of the user.

10. The compression device of claim 1, wherein the sleeve is part of a garment and wherein the garment is selected from a shirt or pants.

11. A method of treating a patient with a compression device, comprising:
attaching to a patient's limb a plurality of sensors and a sleeve comprising a plurality of inflatable chambers;
receiving body impedance values from the sensors by a bio impedance circuit connected to a microcontroller;
sending instructions from the microcontroller to a plurality of pumps based on the values received by the bio impedance circuit;
inflating the inflatable chambers based on the instructions from the microcontroller when the body impedance values meet a first predefined threshold.

12. The method according to claim 11, wherein a duration, pressure, and sequence of the inflating is adjusted according to the body impedance values received from the sensors.

13. The method according to claim 11, wherein the patient is ambulatory during treatment.

14. The method according to claim 11, wherein the device is wearable.

15. The method according to claim 11, wherein the inflating moves lymph fluid away from an affected area of the patient.

16. The method of claim 11, further comprising:
stopping the pumps when the body impedance values received from the sensors reach a second predetermined threshold.

17. The method of claim 16, further comprising:
reinflating the inflatable chambers when the body impedance values return to the first predefined threshold.
